(19) United States
(12) Patent Application Publication
(10) Pub. No.: US 2018/0168398 A1
(43) Pub. Date: Jun. 21, 2018

(54) STORAGE CAN WITH GRINDING UNIT

(71) Applicants: Jui-Te Wang, Taichung City (TW); Jordan S. Tarlow, Venice, CA (US)

(72) Inventor: Jui-Te Wang, Taichung City (TW)

(21) Appl. No.: 15/384,319

(22) Filed: Dec. 20, 2016

(51) Int. Cl. A47J 42/42; A47J 42/14

(52) U.S. Cl. CPC A47J 42/42; A47J 42/14

(57) ABSTRACT

A storage can includes a can having a restriction portion extending inward from the inner periphery of the can. The restriction portion includes multiple blocks extending from a top thereof and a gap is formed between any two adjacent blocks. A base is removably inserted into the can and has multiple first protrusions. Multiple holes are defined through the inner bottom of the base and located alternatively between the first protrusions. A mounting member is rotatably mounted to the top of the base and has multiple second protrusions which are located alternatively to the first protrusions when the mounting member is mounted to the top of the base. Food is ground between the first and second protrusions by rotating the mounting member, and the ground food drops through the holes and is received in the can. A cap is mounted to the can and has a sealing member.

### BACKGROUND OF THE INVENTION

### 1. Fields of the Invention

The present invention relates to a storage can, and more particularly, to a storage can with a grinding unit for grinding food, and a sealing member seals the can to keep the ground food from air.

### 2. Descriptions of Related Art

One of the conventional ways to store food is to use a can which generally comprises a body and a cover which is removably mounted to the top opening of the body. Food is stored in the body and can be accessed by removing the cover from the body. However, some spices like pepper seeds needs to be ground before being used, the users have to pick the pepper seeds from the storage can and use a grinding device to grind the pepper seeds. If there is extra ground pepper, a sealed can or container is used to avoid the ground pepper from absorbing moisture. When collecting the ground pepper, the powder-like ground pepper easily drops or spreads everywhere.

The present invention intends to provide a storage can with a grinding unit, and food can be ground and stored in the can and the users do not need even to touch the food.

### SUMMARY OF THE INVENTION

The present invention relates to a storage can and comprises a can having a room defined therein and a restriction portion extends inward from the inner periphery of the room. The restriction portion includes multiple blocks extending from the top thereof and a gap is formed between any two adjacent blocks. A base is removably inserted into the room from the open top of the can and has a reception area defined in the top thereof. Multiple first protrusions extend from the inner bottom of the reception area and each first protrusion is a cone-shaped protrusion. Multiple holes are defined through the inner bottom of the reception area and located alternatively between the first protrusions. The holes communicate with the room. Multiple legs extend along periphery of underside the base and contact the blocks. A mounting member is rotatably mounted to the top of the base and has a space defined in the underside thereof. The space faces the reception area. Multiple second protrusions extend from the inner bottom of the space and are located alternatively to the first protrusions when the mounting member is mounted to the top of the base.

Preferably, each block includes two peak portions and a valley portion which is connected between the two peak portions. When the legs are located between the blocks, the base cannot rotate relative to the can. When the legs are rested on the valley portions, the base is easily pulled away from the can.

Preferably, the can includes a bottom part and a top part. The outer diameter of the top part is smaller than that of the bottom part so as to form a shoulder between the top part and the bottom part.

Preferably, a cover is mounted to the can and rested on the shoulder by the peripheral wall of the cover. A recessed area is defined in the underside of the cover and an opening is defined through the peripheral wall of the cover. A box is formed on the inner periphery of the peripheral wall of the cover and located corresponding to the opening. The box has a passage which communicates with the opening. A sealing member is connected to the passage and the opening.

Preferably, the sealing member includes a button, a spring and an end piece. The button is located at the opening, and the spring is biased between the button and the wall of the box defining the passage. The wall of the box has an aperture. The end piece is located in the recessed area and has a head and an insertion which extends from the head of the end piece. The head of the end piece contacts outside of the wall of the box and the insertion of the end piece extends through the aperture and is located in the passage. The button has a tubular portion through which the insertion of the end piece extends. The spring is mounted to the tubular portion. When the button is pushed toward the box, the tubular portion of the button pushes the end piece away from the aperture. The button protrudes beyond the opening by the force from the spring. Two grooves are defined in two sides of the button and do not communicate with outer face of the button. The aperture is sealed when the button is not pushed inward. The aperture communicates with the recessed area and the two grooves when the button is pushed inward.

Preferably, the mounting member has a flange extending from the periphery of the top thereof. The flange includes multiple recesses. The flange contacts the base when the mounting member is mounted to the base.

Preferably, one of the first protrusions that is located at the center of the inner bottom of the reception area has a lift part formed on the top thereof. The lift part is a ball.

Food is put between the base and the mounting member, and ground during relative movements between the first and second protrusions by rotating the mounting member relative to the base, and the ground food drops through the holes and stored in the can. During the grinding and storage, the users do not even touch the food.

When lifting the base slightly relative to the can and rotating the base, the legs on the base are engaged with the valley portions. This is convenient for the users to remove the base away from the can and to access the food stored in the can.

The sealing member ensures that the food stored in the can is avoided from being accessed with outside air to keep the food fresh.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the storage can of the present invention;

FIG. 2 is an exploded view of the storage can of the present invention;

FIG. 3 is another perspective view to show the mounting member of the storage can of the present invention;

FIG. 4 is another perspective view to show the base of the storage can of the present invention;

FIG. 5 is a cross sectional view, taken along line V-V of FIG. 1;

FIG. 6 shows that the food is grounded between the mounting member and the base by rotating the mounting member;

FIG. 7 shows that the leg of the base is engaged with one of the valley portions of the can;

FIG. 8 is a cross sectional view, taken along line VIII-VIII of FIG. 7, and

FIG. 9 is a cross sectional view, taken along line IX-IX of FIG. 1.

### DETAILED DESCRIPTION OF THE PREFERRED EMBODIMENT

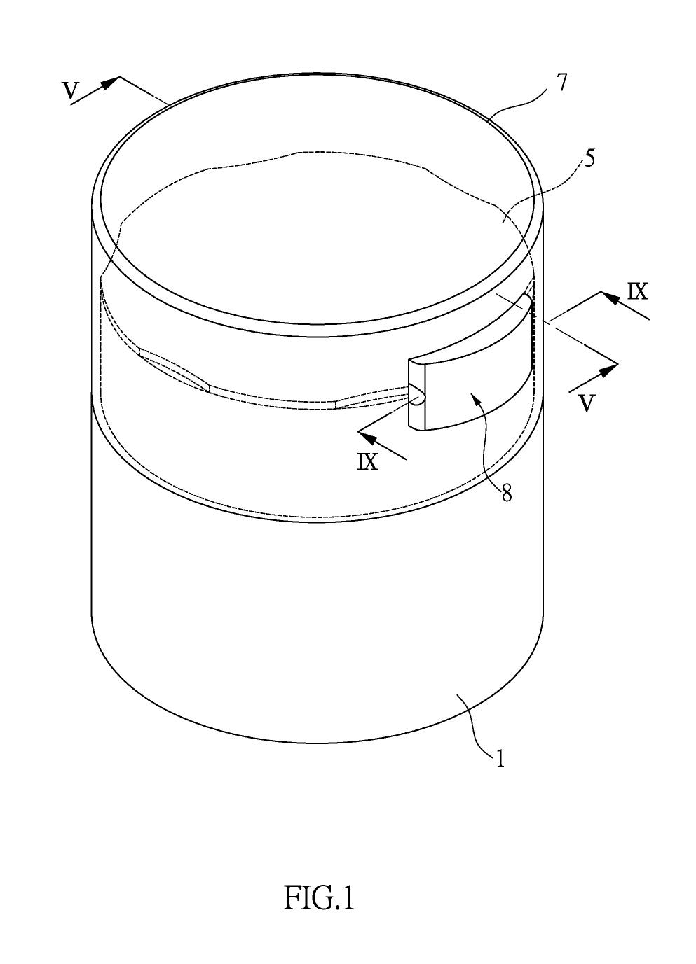

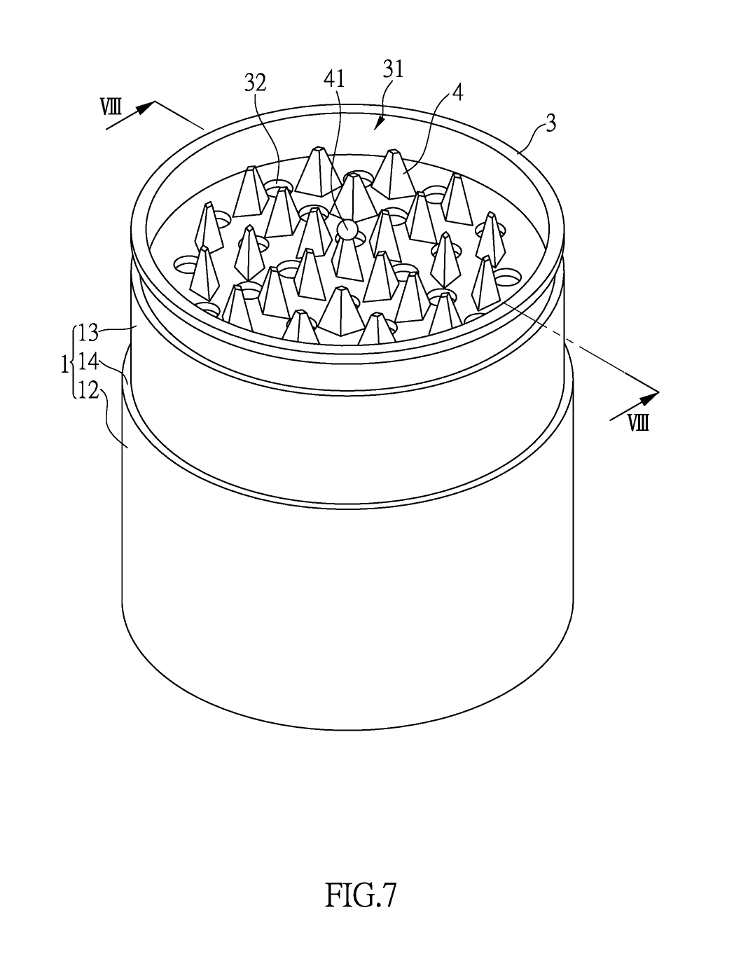

Referring to FIGS. 1 to 9, the storage can of the present invention comprises a can 1 which is a tubular can and has a room 11 defined therein. A restriction portion 2 extends inward from the inner periphery of the room 11 and includes multiple blocks 21 extending from the top thereof. A gap is formed between any two adjacent blocks 21.

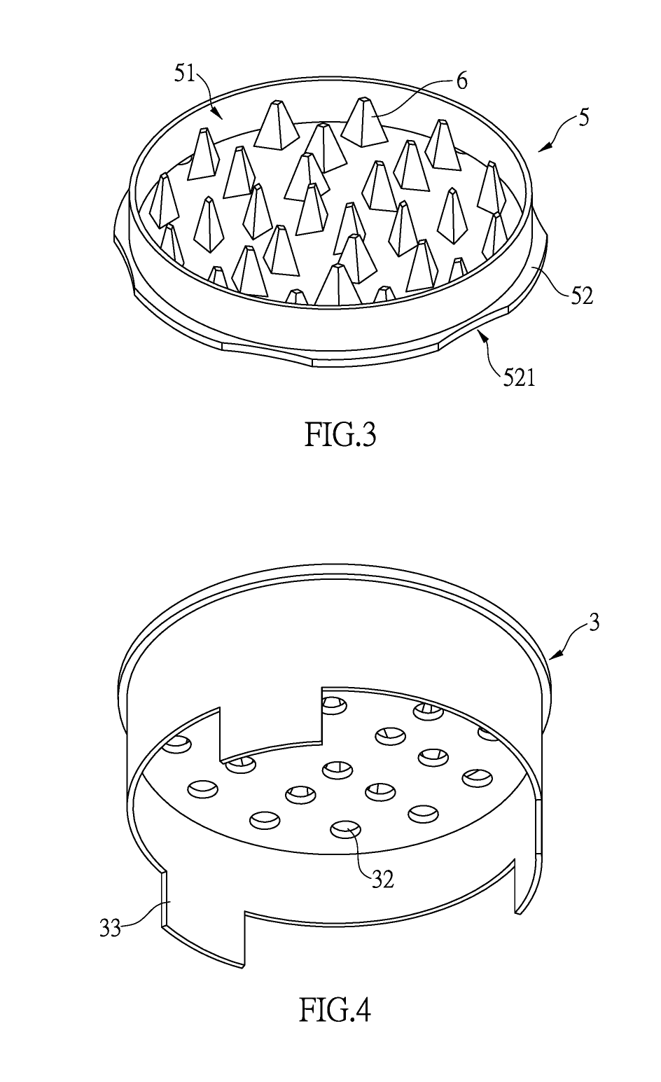

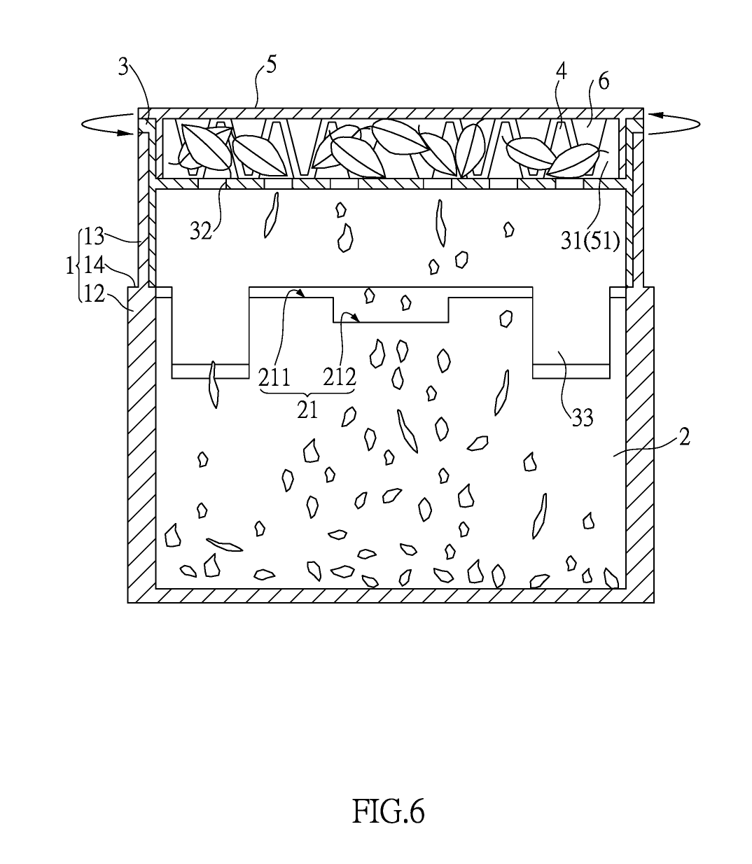

A base 3 is removably inserted into the room 11 from the open top of the can 1 and has a reception area 31 defined in the top thereof. Multiple first protrusions 4 extend from the inner bottom of the reception area 31 and each first protrusion 4 is a cone-shaped protrusion whose tip end faces upward. Multiple holes 32 are defined through the inner bottom of the reception area 31 and located alternatively between the first protrusions 4. The holes 32 communicate with the room 11. Multiple legs 33 extend along the periphery of the underside the base 3 and contact the blocks 21. A mounting member 5 is rotatably mounted to the top of the base 3 and has a space 51 defined in the underside thereof. The space 51 faces the reception area 31. Multiple second protrusions 6 extend from the inner bottom of the space 51 and are located alternatively to the first protrusions 4 when the mounting member 5 is mounted to the top of the base 3. As shown in FIG. 3, the mounting member 5 has a flange 52 extending from the periphery of the top thereof. The flange 52 includes multiple recesses 521, and the flange 52 contacts the base 3. The user holds the flange 52 by inserting fingers in the recesses 521 to rotate the mounting member 5 to grind the food. Each of the first and second protrusions 4, 6 includes sharp edges which are able to cut or grind food when the mounting member 5 is rotated relative to the base 3. The cut or ground food drops through the holes 32 and stored in the can 1. The base 3 can be pulled upward and away from the can 1 so that the users can access the good stored in the can 1. As shown in FIG. 6, food is put between the base 3 and the mounting member 5, and ground during relative movements between the first and second protrusions 4, 6 by rotating the mounting member 5 relative to the base 3, and the ground food drops through the holes 32 and stored in the can 1. During the grinding and storage, the users do not even touch the food.

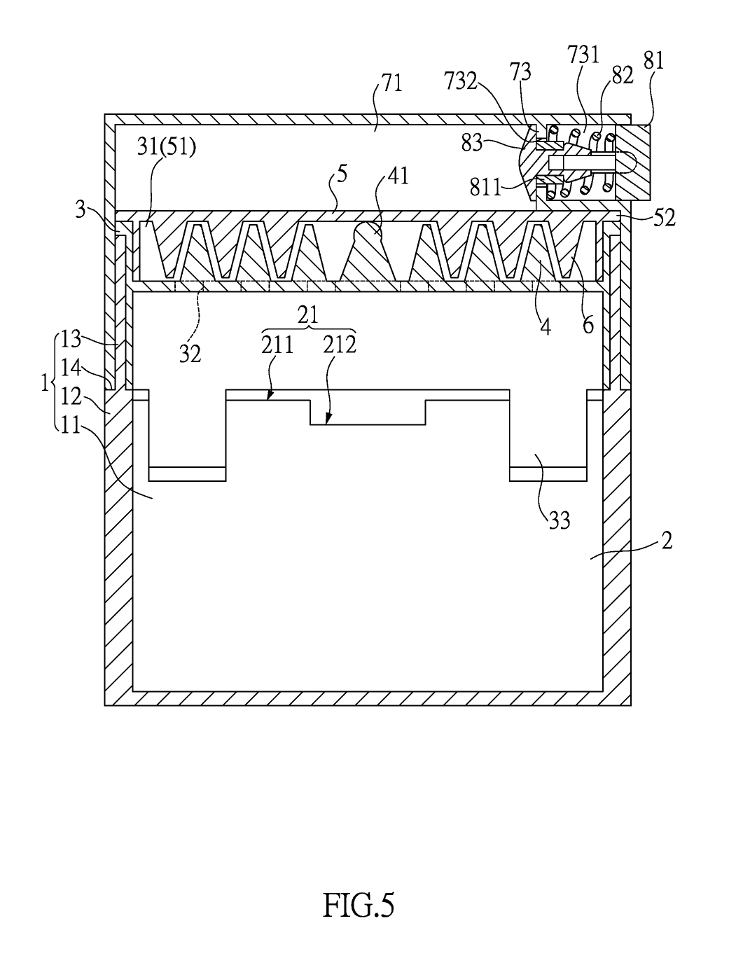

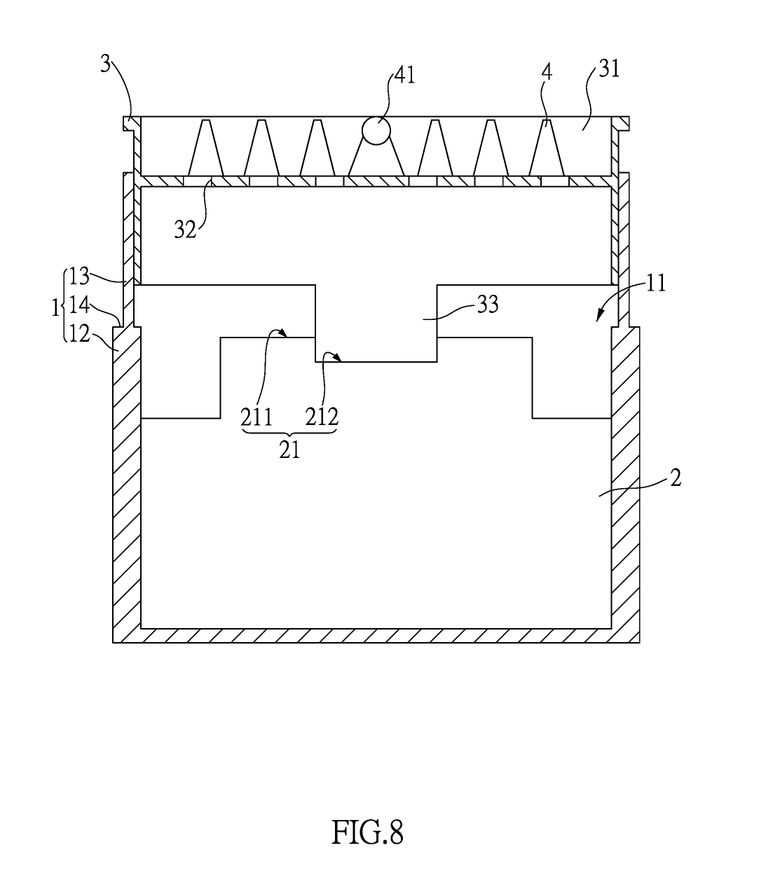

Specifically, each block 21 includes two peak portions 211 and a valley portion 212 which is connected between the two peak portions 211. When the legs 33 are located between the blocks 21, the base 3 cannot rotate relative to the can 1 as shown in FIG. 5. When the legs 33 are located between the blocks 21, the mounting member 5 is rotated relative to the base 3 to cut or grind the food. As shown in FIG. 8, the base 3 is slightly lifted and rotated to let the legs 33 be rested on the valley portions 212, by this way, the base 3 is located at a higher position relative to the base 1 and can be easily pulled away from the can 1 when the users need to access the food in the can 1. Because the valley portions 212 is lower than the peak portion 211, to that when the legs 33 is rested on the valley portions 212, the base 3 does not easily separate from the can 1.

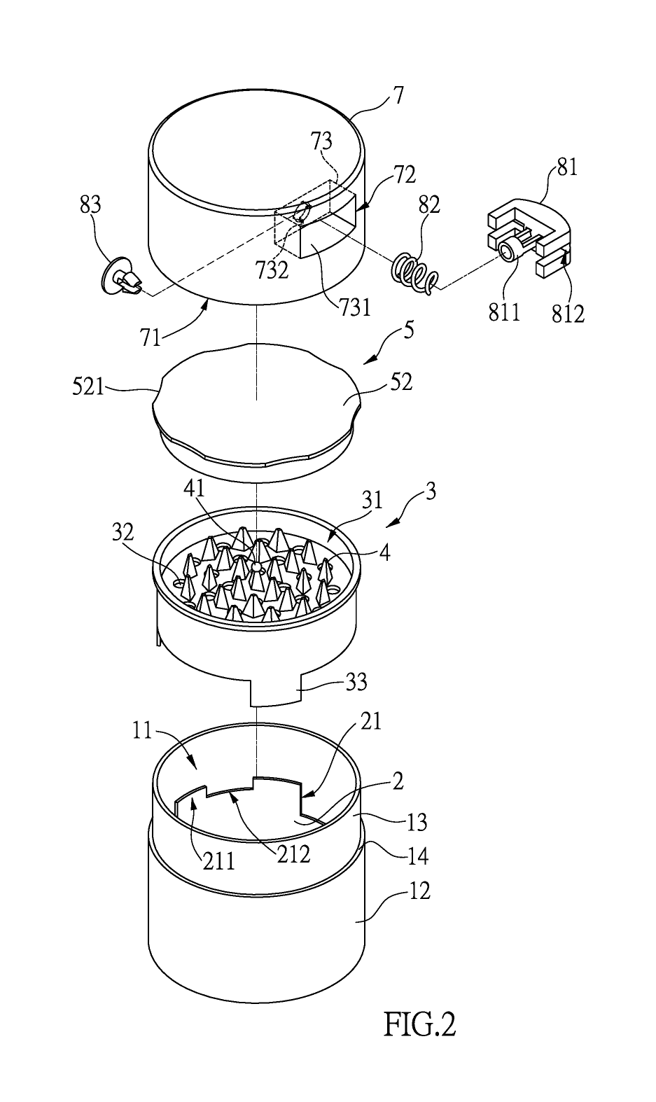

As shown in FIG. 2, one of the first protrusions 4 that is located at the center of the inner bottom of the reception area 31 has a lift part 41 formed on the top thereof. In this embodiment, the lift part 41 is a ball which is designed for convenience of removing the base 3 from the can 1 by holding the lift part 41.

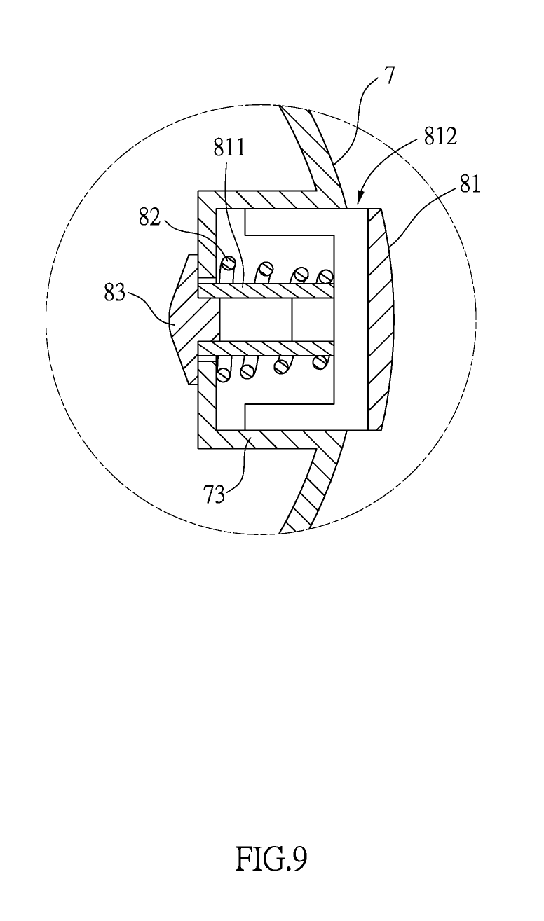

As shown in FIG. 2, the can 1 includes a bottom part 12 and a top part 13. The outer diameter of the top part 13 is smaller than that of the bottom part 12 so as to form a shoulder 14 between the top part 13 and the bottom part 12. A cover 7 is mounted to the can 1 and rested on the shoulder 14 by the peripheral wall of the cover 7. A recessed area 71 is defined in the underside of the cover 7 and an opening 72 is defined through the peripheral wall of the cover 7. A box 73 is formed on the inner periphery of the peripheral wall of the cover 7 and located corresponding to the opening 72. The box 73 has a passage 731 which communicates with the opening 72. As shown in FIGS. 2, 5 and 9, a sealing member 8 is connected to the passage 731 and the opening 72. The sealing member 8 includes a button 81, a spring 82 and an end piece 83. The button 81 is located at the opening 72. The spring 82 is biased between the button 81 and the wall defining the passage 731 of the box 73. The button 81 protrudes beyond the opening 72 by the force from the spring 82. The wall of the box 73 has an aperture 732. The end piece 83 is located in the recessed area 71 and has a head and an insertion which extends from the head of the end piece 83. The head of the end piece 83 contacts outside of the wall of the box 73 and seal the aperture 732, and the insertion of the end piece 83 extends through the aperture 732 and is located in the passage 731. The button 81 has a tubular portion 811 through which the insertion of the end piece 83 extends. The spring 82 is mounted to the tubular portion 811. Two grooves 812 are defined in two sides of the button 81 and always communicate with outside of the can 1. The aperture 732 is sealed when the button 81 is not pushed inward as shown in FIG. 9, therefore, outside air cannot enter into the can so that the food in the can 1 is not affected by air and any foreign objects. The cover 7 is not separated from the can 1 when the button 81 is not pushed inward.

When the button 81 is pushed toward the box 73, the tubular portion 811 of the button 81 pushes the end piece 83 away from the aperture 732. The aperture 732 is opened and communicates with the recessed area 71 and the two grooves 812, so that the pressure in the can 1 and the pressure outside the can 1 is balanced, the cover 7 is easily separated from the can 1.

While we have shown and described the embodiment in accordance with the present invention, it should be clear to those skilled in the art that further embodiments may be made without departing from the scope of the present invention.

What is claimed is:

1. A storage can comprising:
a can (1) having a room (11) defined therein and a restriction portion (2) extending inward from an inner periphery of the room (11), the restriction portion (2) including multiple blocks (21) extending from a top thereof and a gap formed between any two adjacent blocks (21);
a base (3) removably inserted into the room (11) from an open top of the can (1) and having a reception area (31) defined in a top thereof, multiple first protrusions (4) extending from an inner bottom of the reception area (31) and each first protrusion (4) being a cone-shaped protrusion, holes (32) defined through the inner bottom of the reception area (31) and located alternatively between the first protrusions (4), the holes (32) communicating with the room (11), multiple legs (33) extending along periphery of underside the base (3) and contacting the blocks (21), and
a mounting member (5) rotatably mounted to the top of the base (3) and having a space (51) defined in an underside thereof, the space (51) facing the reception area (31), multiple second protrusions (6) extending from an inner bottom of the space (51) and located alternatively to the first protrusions (4) when the mounting member (5) is mounted to the top of the base (3).

2. The storage can as claimed in claim 1, wherein each block (21) includes two peak portions (211) and a valley portion (212) which is connected between the two peak portions (211), when the legs (33) are located between the blocks (21), the base (3) cannot rotate relative to the can (1), when the legs (33) are rested on the valley portions (212), the base (3) is easily pulled away from the can (1).

3. The storage can as claimed in claim 1, wherein the can (1) includes a bottom part (12) and a top part (13), an outer diameter of the top part (13) is smaller than that of the bottom part (12) so as to form a shoulder (14) between the top part (13) and the bottom part (12).

4. The storage can as claimed in claim 3, wherein a cover (7) is mounted to the can (1) and rested on the shoulder (14) by a peripheral wall of the cover (7), a recessed area (71) is defined in an underside of the cover (7) and an opening (72) is defined through the peripheral wall of the cover (7), a box (73) is formed on an inner periphery of the peripheral wall of the cover (7) and located corresponding to the opening (72), the box (73) has a passage (731) which communicates with the opening (72), a sealing member (8 is connected to the passage (731) and the opening (72).

5. The storage can as claimed in claim 4, wherein the sealing member (8) includes a button (81), a spring (82) and an end piece (83), the button (81) is located at the opening (72), the spring (82) is biased between the button (81) and a wall defining the passage (731) of the box (73), the button (81) protrudes beyond the opening (72) by a force from the spring (82), the wall of the box (73) has an aperture (732), the end piece (83) is located in the recessed area (71) and has a head and an insertion which extends from the head of the end piece (83), the head of the end piece (83) contacts outside of the wall of the box (73) and removably seals the aperture, the insertion of the end piece (83) extends through the aperture (732) and is located in the passage (731), the button (81) has a tubular portion (811) through which the insertion of the end piece (83) extends, the spring (82) is mounted to the tubular portion (811), when the button (81) is pushed toward the box (73), the tubular portion (811) of the button (81) pushes the end piece (83) away from the aperture (732), two grooves (812) defined in two sides of the button (81), the aperture (732) is sealed when the button (81) is not pushed inward, the aperture (732) communicates with the recessed area (71) and the two grooves (812) when the button (81) is pushed inward.

6. The storage can as claimed in claim 1, wherein the mounting member (5) has a flange (52) extending from a periphery of a top thereof, the flange (52) includes multiple recesses (521), the flange (52) contacts the base (3) when the mounting member (5) is mounted to the base (3).

7. The storage can as claimed in claim 1, wherein one of the first protrusions (4) that is located at a center of the inner bottom of the reception area (31) has a lift part (41) formed on a top thereof, the lift part (41) is a ball.
